(19) United States
(12) Patent Application Publication
(10) Pub. No.: US 2025/0012126 A1
(43) Pub. Date: Jan. 9, 2025

(54) Powered Garage Door

(71) Applicant: PREMIER DOOR Co., Stewart, MN (US)

(72) Inventor: Nicolas Dale Schuft, Stewart, MN (US)

(21) Appl. No.: 18/894,233

(22) Filed: Sep. 24, 2024

Related U.S. Application Data
(63) Continuation-in-part of application No. 17/111,326, filed on Dec. 3, 2020, now Pat. No. 12,098,585.
(60) Provisional application No. 62/942,843, filed on Dec. 3, 2019.

(51) Int. Cl. E05F 15/53; E05F 7/00; E05F 15/70

(52) U.S. Cl. CPC E05F 15/53; E05F 7/00; E05F 15/70; E05Y 2400/35; E05Y 2900/106

(57) ABSTRACT

A powered garage door pivots about a fixed pivot axis extending between side edges beneath the top edge of the door panel, such that when moving from the closed position to an opened position the top edge moves rearwardly while the bottom edge moves forwardly. A front top header finishing plate is fixed so as to extend downwardly from the header in front of and beneath the top edge of the door panel. An inclinometer sensor is secured to the door panel, sensing the angle of the door panel as it pivots between closed and opened positions. Hydraulic cylinders, which can be housed within uprights defining the door opening, are controlled by the electronic controller based on the inclinometer signal, and a graphical user interface allows the user to set both zone sizes (based on inclination angle) and zone speeds, independently for opening and closing.

### CROSS-REFERENCE TO RELATED APPLICATION(S)

The present application is a continuation-in-part of U.S. patent application Ser. No. 17/111,326, filed Dec. 3, 2020 and now issued as U.S. Pat. No. 12,098,585, which claims the benefit of U.S. provisional patent application Ser. No. 62/942,843, filed Dec. 3, 2019, both entitled “Powered Garage Door”. The contents of U.S. patent application Ser. No. 17/111,326 and provisional patent application Ser. No. 62/942,843 are hereby incorporated by reference in their entirety.

### BACKGROUND OF THE INVENTION

The present application relates to what are commonly referred to as garage doors (regardless of whether installed on a garage or on a different building), and to methods and structures for powering garage doors between open and closed positions. While many garage doors have multiple panels in which all of the panels translate during the opening/closing movement, the present invention is primarily directed to garage doors having at least one panel which pivots about a stationary pivot axis. Typically, the power for opening or closing is provided by one or more power cylinders which lengthen or shorten to provide the movement. In many instances, the power for the power cylinders will be hydraulic. While such garage doors can be used in residential applications, they are primarily used in aviation, commercial and industrial settings.

For instance, U.S. Pat. Nos. 6,883,273, 8,327,586, and 8,800,208, 9,523,233, 10,604,991 each disclose this type of garage door formed as a single panel. U.S. Pat. Nos. 7,814,957 and 8,714,229 each disclose this type of garage door formed of two panels. The single or top panel of the door is hinged by a piano hinge or a series of hinges along its top surface to a header over the door. While such doors could be formed of wood or similar material, in most applications the door panel itself is primarily formed by a skeleton of vertical and horizontal metal supports which are welded together, with a sheet of thin material (typically sheet metal) connected on one side (typically the outer side) of the skeleton. As an example, the size of one prior art hydraulically powered garage door formed of a single panel is nearly fourteen feet tall and over forty-eight feet wide. The top hinged connection may be finished with a rubber seal to prevent water, etc. from coming in and/or to protect the hinged connection. Better, less costly, and more water and weatherproof powered garage doors are needed.

### SUMMARY OF THE INVENTION

The present invention is a powered garage door which, in one aspect, has an improved pivot structure for the door panel, in another aspect, has an improved control strategy, and, in another aspect, has an improved upright structure. Pivot connectors are used about a fixed pivot axis extending from the one side edge to the other side edge beneath the top edge of the door panel, such that when moving from the closed position to an opened position the top edge moves rearwardly while the bottom edge moves forwardly. At least a front top header finishing plate is fixed so as to extend downwardly from the header in front of and beneath the top edge of the door panel, such that the front top header finishing plate resists precipitation entry between the header and the top edge of the door panel. An inclinometer sensor is secured to the door panel, sensing the angle of the door panel as it pivots between closed and opened positions. The rate of extension or retraction of the linear actuator(s) is controlled by the electronic controller based on the inclinometer signal, and a graphical user interface allows the user to set both zone sizes (based on inclination angle) and zone speeds, independently for opening and closing. In one embodiment, the right and left uprights each define a chamber for receiving a respective hydraulic cylinder, and further each include a vertical channel receiving a seal, positioned against the back of the door panel and on the center side of the hydraulic cylinder, to restrict air flow between the door and the column.

### BRIEF DESCRIPTION OF THE DRAWINGS

The present invention is described with reference to the attached drawing sheets, in which:

FIG. 1 is a perspective view of a first embodiment of a preferred door panel for use in the powered garage door in accordance with the present invention, shown from behind the door, exploded to show the difference between the welded door skeleton and the sheet material.

FIG. 2 is an exploded perspective view of the upper right corner of the preferred door skeleton of FIG. 1, shown from in front of the door (without the sheet material).

FIG. 3 is an exploded perspective view of a preferred left upright and hydraulic cylinder for use in the powered garage door in accordance with the present invention, shown from in front of the upright. The right upright is identical, with the mounting bracket and hydraulic cylinder mounted in an opposing symmetrical arrangement.

FIG. 4 is an exploded perspective view of the bushing support assembly and bushing at the top of the upright of FIG. 3.

FIG. 5 is a side view of the preferred power garage door in accordance with the present invention in the opened position, but also showing the cylinder position in the closed position in dashed lines.

FIG. 6 is an enlargement of the pivot connector shown in FIG. 5, but also showing the top of the door panel in the closed position in dashed lines.

FIG. 7 is an elevational view of the preferred power garage door in accordance with the present invention in the opened position, from in front of the door.

FIG. 8 is a cross-sectional plan view of the left side of the preferred power garage door in accordance with the present invention in the closed position, taken along the pivot axis.

FIG. 9 is a hydraulic schematic for the preferred power garage door in accordance with the present invention.

FIG. 10 is a screenshot of one of the set-up screens on the preferred graphical user interface of the present invention.

FIG. 11 is a perspective view of a pair of uprights and header used in an alternative garage door, and showing several preferred dimensions.

FIG. 12 is a cross-sectional plan view of the alternative left upright of FIG. 11, taken at cut-lines 12-12 in FIG. 11, and showing several further preferred dimensions.

FIG. 13 is a perspective view of the alternative left upright, showing the hydraulic cylinder and its attachment structures in exploded view.

FIG. 14 is an enlarged view of the upper portion of the alternative left upright of FIG. 13, showing the bushing assembly for pivotally supporting the door panel in exploded view.

FIG. 15 is a rear view of the alternative left upright of FIGS. 11-14.

FIG. 16 is a left side view of the alternative left upright of FIGS. 11-15, showing the hidden hydraulic cylinder and door panel in dashed lines.

FIG. 17 is a front view of the alternative left upright of FIGS. 11-16.

FIG. 18 is a top plan view of the alternative left upright of FIGS. 11-18, further showing the compressible seal member.

While the above-identified drawing figures set forth preferred embodiments, other embodiments of the present invention are also contemplated, some of which are noted in the discussion. In all cases, this disclosure presents the illustrated embodiments of the present invention by way of representation and not limitation. Numerous other minor modifications and embodiments can be devised by those skilled in the art which fall within the scope and spirit of the principles of this invention.

### DETAILED DESCRIPTION

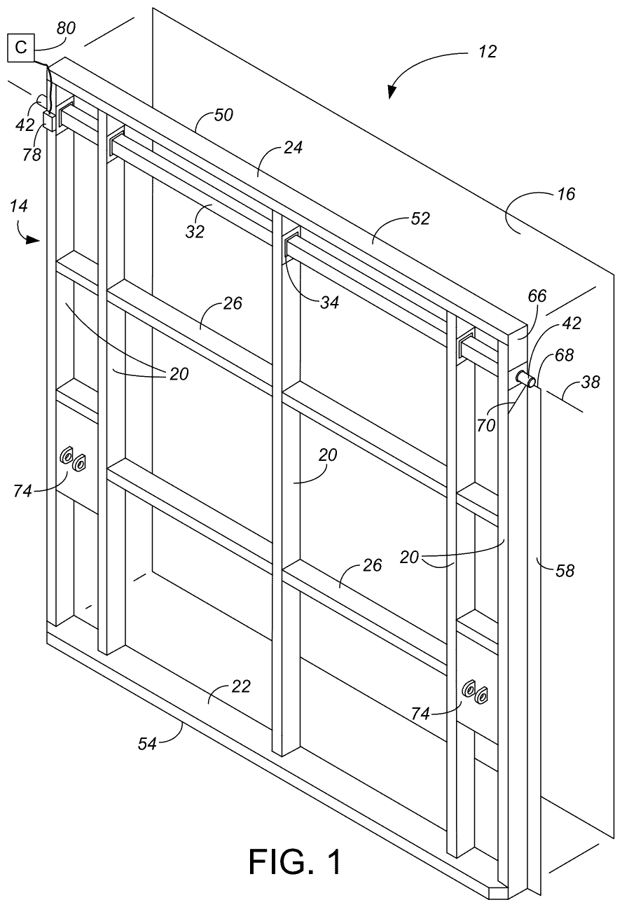

The present invention is a powered garage door 10 which uses at least one door panel 12, a simple and small version of which is shown in FIG. 1. While the door panel could be a top door panel of a bi-fold door with another panel (not shown) hinged to a bottom edge 54 of the door panel 12 shown, more preferably the door panel 12 is used for a single panel garage door. The single panel door of the present invention has fewer moving parts than many other types (bi-or multi-fold, lift-strap or sliding) of garage doors, often resulting in lower maintenance costs and repair problems over time. The powered garage door 10 is used in a building (not shown) most commonly having vertical walls (not shown), in which case the closed position of the door panel 12 is in a vertical plane generally coplanar with one of the building walls.

The door panel 12 is preferably formed as a skeleton frame structure 14 supporting a sheet 16 of thin material. While the door panel 12 could be partially or fully made of wood or other organic building materials or of polymer materials, and while part or all of the sheet material 16 could alternatively be glass, more preferably both the skeleton frame structure 14 and the sheet material 16 are formed of metal, with aluminum or more preferably steel being common choices. The sheet material 16 is relatively flat, with any surface texture or pattern being at least less than half of the thickness or depth of the skeleton frame structure 14, and more preferably having any surface texture or pattern be less than half of an inch from a plane defined by the door panel 12. In the most preferred embodiment, the door skeleton 14 and support uprights 18 are formed from commercial grade steel to out-last and out-perform other hydraulic doors. The preferred skeleton 14 includes vertical (with “vertical” being oriented in accordance with the closed position of the door panel 12) studs 20 which run the height of the door panel 12 between a foot plate 22 and a top plate 24. The spacing between the vertical studs 20 can be selected as desired for the strength requirements of the door 10 and the materials and stud strengths selected, with one preferred spacing being at about six foot intervals, i.e., the door panel 12 depicted in FIG. 1 is about fourteen feet wide. Another preferred spacing uses vertical studs spaced at three to four foot intervals. For wider door panels up to about fifty feet wide, more vertical studs 20 are used. The lengths of the vertical studs 20 depends upon the desired height of the door panel 12, with the door panel 12 depicted in FIG. 1 being generally square and about fourteen feet tall. To minimize cost, the vertical studs 20 have a cross-section which matches those commonly used in wall construction, such as (in the United States) being tubular of about 1½×3½ inch outer dimensions, with the depicted foot plate 22 being tubular of about 1½×5½ inch outer dimensions. The 3½ thickness or depth of the vertical studs 20 generally establish the thickness of the door panel 12 when view from the side. The sheet metal 16 is attached on what will commonly be the outer or front side of the door 10 when hung on the building, so the sheet metal 16 is exposed to the elements such as precipitation and sunlight and protects the skeleton 14 and the interior of the building from the elements. Horizontal braces 26 are welded or otherwise suitably connected between the vertical studs 20. The horizontal braces 26 can be sized to match the vertical studs 20, i.e., about 1½×3½ inch outer dimensions. While angled or additional braces could be used to add strength to the skeleton frame 14, the preferred embodiment rigidly attaches the sheet metal 16 to the skeleton frame 14 at numerous locations, and the sheet metal 16 helps maintain the right angles of the skeleton frame 14. While most garage doors are rectangular with a horizontal foot plate 22 and a horizontal top plate 24, the present invention can also be used in other shapes or layouts of garage doors.

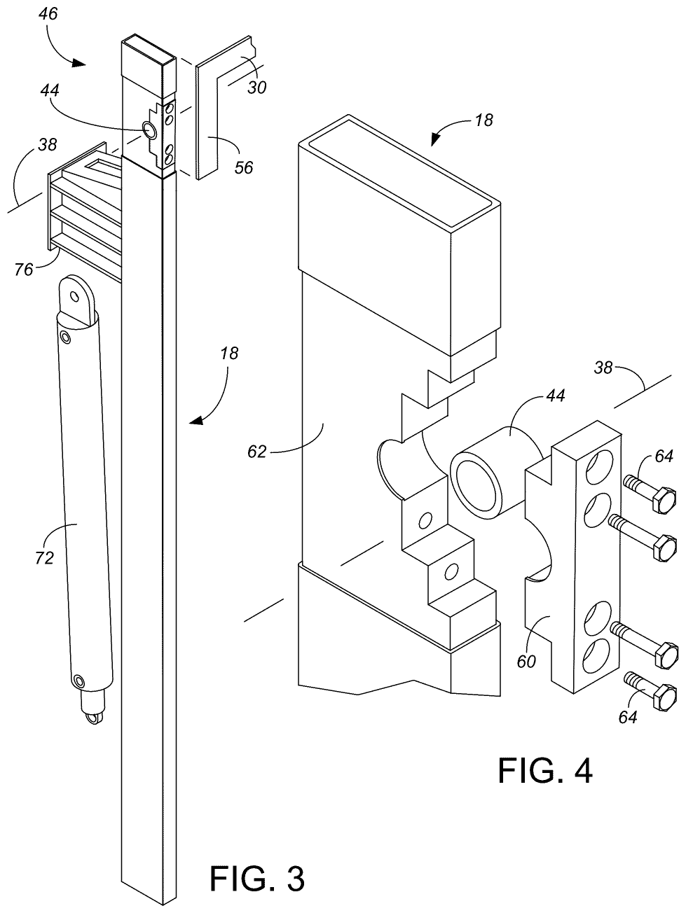

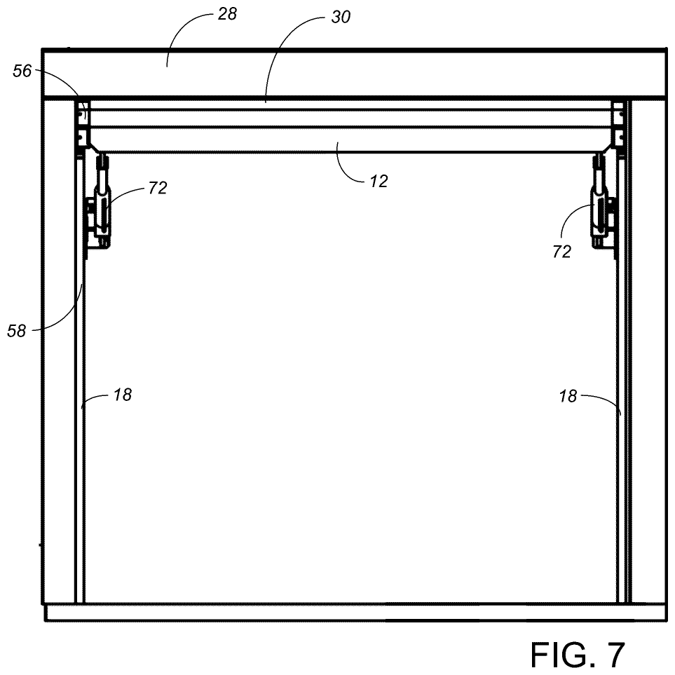

When positioned in the wall of a building, the door opening will be defined by two uprights 18 supporting ends of a door header 28, which can be considered left and right uprights when facing the door opening from outside the building. A preferred left upright 18 is shown in FIG. 3, with its top portion better shown in FIG. 4. The door header 28, best shown only in FIG. 7, is mostly insignificant to the present invention other than supporting the front top header finishing plate 30, and can be formed as convenient for the building wall construction. In use, the door panel 12 in the closed position will be in plane with the plane defined by the uprights 18 and the door header 28, and most preferably with the front sides of the uprights 18 and the door header 28 being generally in plane with the front side of the door panel 12.

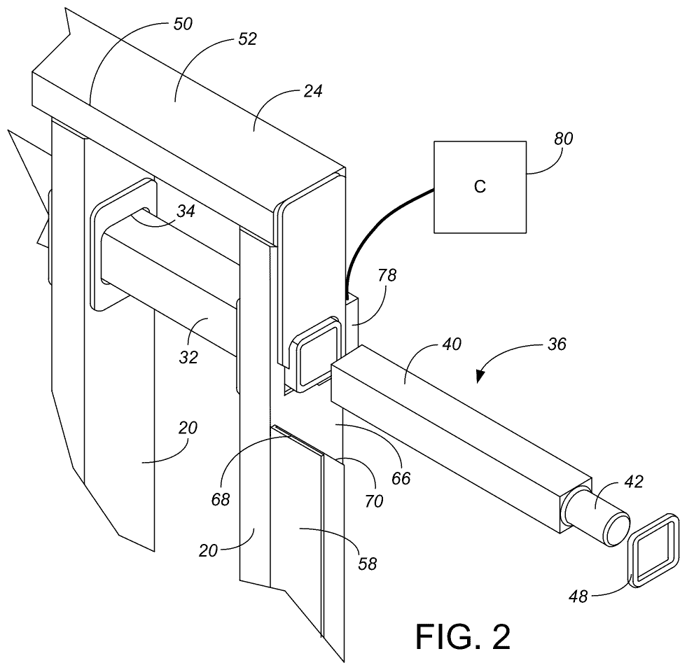

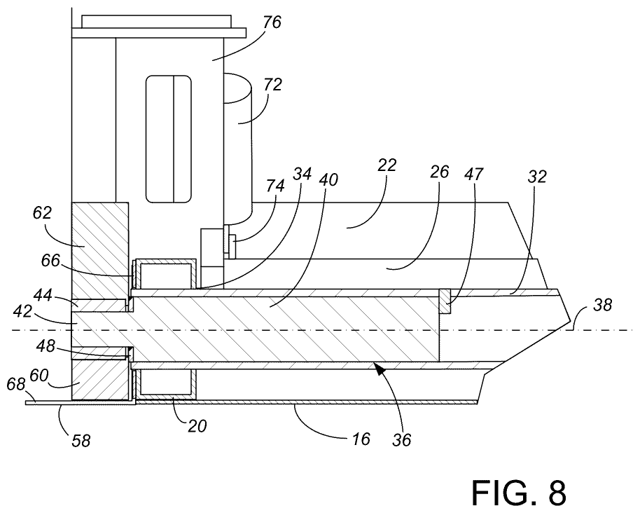

The skeleton 14 also includes a pivot tube 32. With use of the pivot tube 32, the preferred door 10 of the present invention has no hinge along its top edge, and is referred to as a “zero hinge” or “zero visible hinge” door 10. In the preferred embodiment, the pivot tube 32 is generally square in cross-section and hollow. The pivot tube 32 preferably runs the entire length of the door panel 12, slightly lower than the top plate 24 but separate from the top plate 24. To have the pivot tube 32 run the entire length of the door panel 12, cutouts 34 are made into and through centers of the vertical studs 20. As shown in FIG. 2, each end of the pivot tube 32 is open to receive a (left or right) pivot arm 36 which defines the pivot axis 38 for the door 10. For instance, the pivot tube 32 can define a 2×2 inch inner longitudinal recess on each end. The preferred pivot arms 36 each include a rectangular section 40 which after assembly resides inside the pivot tube 32 and a cylindrical section 42 which after assembly extends outside the ends of the pivot tube 32, past the respective side edge of the door panel 12. Each cylindrical section 42 is in turn received within a respective left/right stationary bushing 44 supported in a respective left/right bushing assembly 46. As known in the bearing art, the stationary bushings 44 are formed of a smooth, lubricious material relative to the pivot arm 36, so as to provide bearing support while minimizing rotational friction. Alternatively, ball bearings or other similar known bearing structures could be used to reduce friction for the pivoting motion of the door panel 12. The cylindrical sections 42 of the pivot arm 36 must be strong enough to carry the substantial entirety of the weight of the door panel 12 without shearing, and in preferred embodiments are each within the range of about 1 to 2 inches in diameter. The rectangular section 40 of each pivot arm 36 must extend for a sufficient length and mate with the interior of the pivot tube 32 sufficiently tightly to hold the pivot arm axis horizontal, coincident with the pivot tube axis, despite the moment put on the pivot arm 36 by the weight of the door panel 12. To better resist such shear, each left/right cylindrical door pivot 42 is preferably integrally formed with the rectangular section 40 of the respective left or right pivot arm 36, such as both out of solid steel. In the preferred embodiment, each rectangular section 40 extends for at least 2 inches, and more preferably for about 12 inches or more within the pivot tube 32. A stop 47 (shown only in FIG. 8) may be positioned within the pivot tube 32 for each pivot arm 36 so the pivot arm 36 cannot be further inserted into the pivot tube 32 than desired. Left and right spacers 48 can be used to help ensure proper side to side positioning of the door panel 12 relative to the respective left/right uprights 18. In an alternative embodiment (not shown), one or more rectangular sections 40 are separately formed from the cylindrical section 42 and is/are much shorter than the cylindrical section 42. At least one rectangular section 40 is preferably fixed to each of the respective cylindrical sections 42 such as by welding. Such rectangular sections primarily support their respective cylindrical section 42 coaxially with the pivot tube 32, which purpose can be served even if the one or more rectangular sections 40 are formed out of plate material.

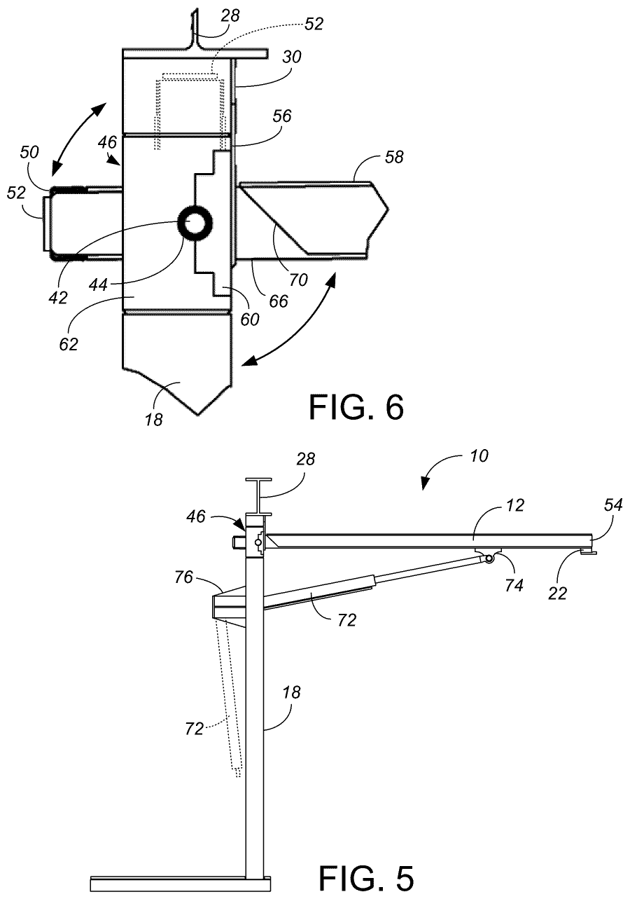

In the preferred embodiment, the pivot axis 38 for the door 10 coincides with the longitudinal axis of the pivot tube 32, centered front to back within the door skeleton 14. This places the door pivot axis 38 significantly further back than many prior art hinged constructions, which placed the door pivot axis entirely in front of the skeleton. This also places the door pivot axis 38 closer to the sheet material 16 than the 3½ inch thickness or depth of the studs 20. With such a front/back centered-in-skeleton pivot axis 38, the front corner 50 of the top plate 24 is about 1¾ inches in front of the pivot axis 38. This also places the door pivot axis 38 significantly lower with respect to the top of the door panel 12 than many prior art constructions using a stationary pivot axis, which placed the door pivot axis entirely above the skeleton. Because the door pivot axis 38 is below the top of the door panel 12, the top edge 52 of the door panel 12 moves rearwardly under the bottom surface of the header 28 during opening while the bottom edge 54 of the door panel 12 moves forwardly. The vertical separation between the pivot tube 32 and the top plate 24 ends up defining the gap-when-open between the door panel 12 and the building header 28, which in most applications should be held relatively small. The vertical separation between the pivot tube 32 and the top plate 24 (together with the thickness of the door panel 12) also determines how much the front corner 50 of the top plate 24 will rise during opening of the door panel 12. If the pivot tube 32 abuts the top plate 24, the pivot axis 38 will be about 2¾ inches below the front corner 50 of the top plate 24, so that door panel rotation would require a gap (assuming a rectangular cross-section header 28) of more than ½ inch of the header 28 over the top plate 24. More preferably the pivot axis 38 is between 3 and 12 inches lower than the front corner 50 of the top plate 24. In the preferred embodiment of FIGS. 1-8, the spacing between the pivot tube 32 and the top plate 24 places the pivot axis 38 about 6¾ inches below the front corner 50 of the top plate 24, so a gap or clearance (assuming a rectangular cross-section header 28) of only about ¼ inch of the header 28 over the top plate 24 is necessary to account for the upward and rearward rotation of the front corner 50 of the top plate 24 during opening.

The preferred zero visible hinge arrangement allows the top edge 52 of the door panel 12, where the door panel 12 in the closed position abuts or meets with the customer header 28, to be finished with a front top header finishing plate 30, without having to cover or seal a piano hinge arrangement. The top finishing plate 30 is stationary throughout opening and closing of the door 10. The top finishing plate 30 is preferably machined of metal, and can extend immediately in front of the top edge 52 of the door panel 12 when closed, thereby preventing precipitation from entering the building past the top edge 52 of the door panel 12. That is, because the opening motion of the door 10 causes the top edge 52 of the door panel 12 to move rearwardly, the lower edge of the top finishing plate 30 can be at an elevation slightly lower than the top edge 52 of the door panel 12 is when closed. Thus, the top header finishing plate 30 projects downward with its bottom edge at least ¼ inch or more lower than the bottom of the header 28, fully covering the gap between the top of the door panel 12 and the header 28, helping to prevent entry of precipitation over the top of the door panel 12. The top finishing plate 30 can be finished to provide a sleek decorative appearance to the outside of the door 10. The top finishing plate 30 can also provide a stop for the door panel 12 when closing, when the top edge 52 of the door panel 12 contacts the rear surface of the top finishing plate 30 to complete its motion forward. If desired, the closed position may involve pressing the top edge 52 of the door panel 12 against the back surface of the top finishing plate 30, further sealing the top edge 52 of the door panel 12 against the elements and entry of precipitation while closed.

In the preferred arrangement, two (left and right) stationary upper side finishing plates 56 extend downwardly lower than the top edge 52 of the door panel 12 and lower than the bottom of the top finishing plate 30, but in plane with the top finishing plate 30. As best seen in FIG. 3, each stationary upper side finishing plates 56 is located at a width and elevation which covers the upper portion of the respective left/right upright 18 and at least partially covers the front of the door column pivot assembly 46. In the preferred embodiment, each upper side finishing plate 56 is fixed so as to extend downwardly from an end of the front top header finishing plate 30. For the portion of the left or right upper side finishing plate 56 which is more than 1¾ inches above the pivot axis 38, the upper side finishing plate 56 can extend inwardly to cover the seam where the door panel 12 abuts with the respective upright 18, but the preferred upper side finishing plates 56 do not cover these seams. Instead, the preferred upper side finishing plates 56 extend downward to a location lower than the fixed pivot axis 38, so as to be in plane and vertically in line with the respective two (left and right) primary front side edge finishing plates 58 (discussed below) when the door panel 12 is in the closed position.

In the preferred embodiment, each of the bushings 44 are held in place within a respective left/right bushing assembly 46, one of which is best shown in FIGS. 3 and 4. In contrast with the hollow uprights 18, each bushing assembly 46 includes a front bracket 60 releasably secured to a back bracket 62, both of which are formed of solid metal. The front bracket 60 and the back bracket 62 sandwich and hold the respective bushing 44. Fasteners such as bolts 64 secure the front bracket 60 to the back bracket 62 and are preferably removable with a tool, so the front bracket 60 and respective cylindrical bushing 44 can be removed from the respective back bracket 62, thereby facilitating assembly or disassembly of the door panel 12 to the bushings 44 and side uprights 18.

To further complete both the aesthetic look of the door 10 and its ability to seal out precipitation, the preferred embodiment also includes two (left and right) primary side finishing plates 58 best shown in FIGS. 1 and 2. Unlike the top finishing plate 30, the primary side finishing plates 58 are preferably attached to the door panel 12 and move with the door panel 12. Each of the primary side finishing plates 58 are constructed like an angle iron with one of its sides attached to the side edge 66 of the door panel 12, extending upward from the bottom 54 of the door panel 12 to just below the respective upper side finishing plate 56. For a door panel 12 which opens to 90°, the maximum height of the tops of the primary side finishing plates 58 is one half the door panel thickness lower than the pivot axis 38, i.e., 1¾ inches lower than the pivot axis 38, before the upper edge 68 of the primary side finishing plate 58 contacts the front of the bushing assembly 46 when the door panel 12 is fully opened. The primary side finishing plates 58 extend immediately in front of the respective support columns 18 while the door 10 is in the closed position, thereby preventing precipitation from entering the building past the side edges 66 of the door panel 12. That is, because the opening motion of the door panel 12 causes the side edges 66 of the door panel 12 beneath the pivot axis 38 to move forwardly, the outer edge of each of the primary side finishing plates 58 can be wider than the respective inside edges of the respective support columns or uprights 18. The primary side finishing plates 58 are preferably machined of metal and have the same type of finishing as the top finishing plate 30 to provide the sleek aesthetic appearance to the door 10 as a whole. The preferred door-attached side finishing plates 58 have the identical width and alignment as the stationary upper side finishing plates 56, each mating closely below the respective stationary upper side finishing plate 56 when the door 10 is closed. So there is no interference between the door-attached side finishing plates 58 and the in-line stationary upper side finishing plates 56 during the opening/closing motion, the back 70 of the angle iron is cut at an angle shown in FIGS. 1 and 2. The arrangement of the finishing plates 30, 56, 58 thus provides a modernized appearance for seamless integration into a building design to meet the demands of top architects and designers. During closing of the door 10, the primary side finishing plates 58 act as a stop to prevent further rotation of the door panel 12 beyond the vertical orientation. If desired, the closed position may involve pressing the primary side finishing plates 58 against the uprights 18, further sealing the side edges 66 of the door panel 12 against the elements and entry of precipitation while closed.

As one alternative, stationary side finishing plates (not shown) could be provided, attached to the front face of the uprights 18, which do not extend in front of the side edges 66 of the door panel 12 when closed, such as extending finishing plates 56 for the entire height of the door. This would allow the side edges 66 of the door panel 12, beneath the pivot elevation, to move forwardly as the door panel 12 is opened, without interference with the side finishing plates. As one alternative to including side finishing plates (which in some embodiments are omitted), the support columns or uprights 18 could be finished to match the top finishing plate 30 and complete the look of the door 10. However, in either of these alternative arrangements, any gap between the side edges 66 of the door panel 12 and the support columns 18 would be exposed from outside with a greater possibility of precipitation entry past the side edges 66 of the door panel 12.

Motion for the door panel 12 to move between closed and opened positions is provided by one or more linear actuators 72. The preferred embodiment uses two linear actuators 72, mounted along the side edges 66 of the door panel 12, each pivotally attached to the door panel 12 at an attachment bracket 74. Because the top of the door panel 12 moves rearward upon opening, the linear actuator could be mounted for attachment at the top of the door panel 12 (i.e., positioning the attachment bracket 74 three to twelve inches above the pivot axis 38), such as extending horizontally behind and above the door opening and mounted hanging from the building ceiling (not shown). However, with the pivot axis 38 being close to the top of the door panel 12, the moment arm for opening the door panel 12 is longer if the attachment bracket 74 is lower in the door panel 12 and further away from the pivot axis 38 than three to twelve inches. The preferred embodiment places the attachment bracket 74 an appropriate distance for the length of the throw of the linear actuator 72.

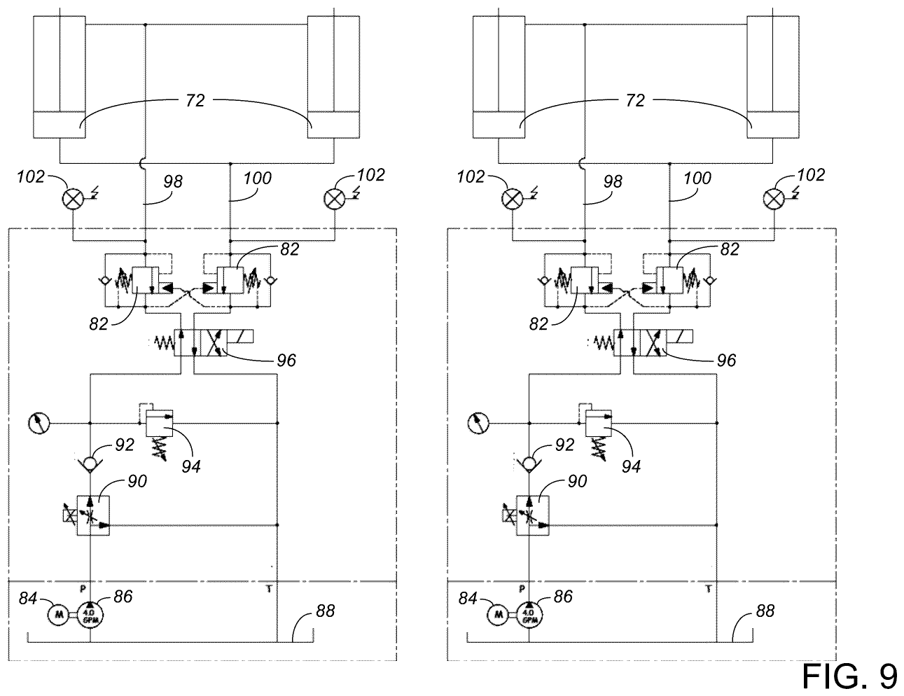

The preferred linear actuators are hydraulic cylinders 72, which are known in the art for opening and closing garage doors. Each hydraulic cylinder 72 is controllable to extend from a shortened position to a lengthened position or to retract from the lengthened position to the shortened position. For instance, the preferred hydraulic cylinders 72 have a shortened length of about 90 inches, and a throw of at least 38 inches to the lengthened position. The hydraulic schematic of FIG. 9 can be used to control the extension and retraction of the two hydraulic cylinders 72. If only one hydraulic cylinder is used, the hydraulic circuit may be only one half of the hydraulic circuit shown in FIG. 9.

The back end of each hydraulic cylinder 72 is mounted with a pivotal attachment, preferably at an elevation above the attachment bracket 74 when the door 10 is closed. To provide an opening moment for the door panel 12, the back pivot of the hydraulic cylinder 72 must be behind a line extending between the attachment bracket 74 and the pivot axis 38. At the same time, the back end of the hydraulic cylinder 72 is preferably as close to the door panel 12 as possible, so the hydraulic cylinder 72 interferes with less of the room space behind the door panel 12. In the preferred embodiment of FIGS. 1-8, the back end of each hydraulic cylinder 72 is mounted from a fixed bracket 76 supported by the upright tube 18, with the pivot location being several inches just laterally inside the upright tube 18 and several inches behind the upright tube 18. When the door 10 of FIGS. 1-8 is closed with the cylinders 72 in their shortened length, the preferred cylinders 72 extend at about 6° relative to the plane of the door panel 12 and at about 10° relative to a line extending between the attachment bracket 74 and the pivot axis 38, meaning that initially about 17% of the cylinder force is used as a rotational moment for moving the door panel 12 away from its fully closed position.

As best shown in FIG. 5, the preferred fully opened position of the single panel door positions the door panel 12 at a 90° angle or horizontal position, useful such as for providing a canopy when open for a vehicle such as a helicopter or jet. To achieve the horizontal position, the fixed pivot location for the hydraulic cylinders 72 must be below the pivot axis 38 of the door panel 12. In the preferred construction, the entirety of the fixed bracket 76 is lower than a bottom of the hollow tubular crossbar 32 (when the door panel 12 is both in the closed position and in the opened position, since neither the fixed bracket 76 nor the tubular crossbar 32 change elevation during the door panel motion). In the preferred mounting arrangement, this results in each hydraulic cylinder 72, in its lengthened, fully opened position, being at an angle of about 10° past horizontal.

Another aspect of the invention is the way in which the hydraulic system is electronically controlled for best opening and closing motion of the door panel 12, referred to as “smart door” technology. Rather than utilize a measurement of cylinder stroke, hydraulic pressure or a pure time-based system, an inclinometer 78 is mounted to the door panel 12 to electronically detect the door panel angle relative to vertical. In the preferred embodiment, a single axis inclinometer 78 is used, which measures the angle of the door panel 12 relative to its closed position during opening and closing at a relatively low cost. Alternatively, a dual axis inclinometer can be used to maintain balance between the two hydraulic cylinders 72, in addition to controlling the opening or closing of the door. The most preferred embodiment utilizes a LCH-A-S-90-10-05 inclinometer 78 available from Level Developments Ltd. of Croydon, Surrey, United Kingdom, which uses two solid state MEMS sensors in a small aluminum package to output a 0.5 to 9.5V differential analog output on a continuous-outdoor rated cable over a potential full scale range of +90°. The inclinometer 78 may be mounted anywhere on the door panel 12 as convenient, and one preferred embodiment mounts the inclinometer 78 on one of the studs 20 near the pivot tube 32, for less motion of the inclinometer cable during opening and closing of the door panel 12. The signal from the inclinometer 78 is electrically fed to a controller 80 (shown schematically in FIGS. 1 and 2), which in turn adjusts two proportional valves 82 (shown in FIG. 9) to regulate hydraulic flow.

The preferred hydraulic circuit for the two hydraulic cylinders 72 is represented by the schematic shown in FIG. 9. The systems use two 120-600 VAC 1-30 Hp motors 84 and 5 Hp oil cooled, pressure loaded submersible gear pumps 86 each operating up to a 4.0 GPM flow rate.

The pumps 86 run cooler and more efficiently than pumps in many prior art systems. The pumps 86 are contained in a reservoir 88 provided by a nicely contained durable Roto-mold hydraulic tank, keeping dust out and providing rust resistance and protection from contaminants, suitable for any environment. Having the pumps 86 installed below oil level allows for performance in all weather conditions, eliminating seasonal adjustment issues due to external flow control which is common on insufficient hydraulic power units by others. Each pump 86 includes a manifold mount to supply hydraulic oil through a 3 port valve 90, check valve 92 and 2500 PSI pressure relief valve 94 to a 24 VDC solenoid operated open/close valve 96. The open/close valve 96 is controlled by the controller 80 to determine whether pressurized oil is being provided to the rod side 98 (in the normal position shown) or to the bore side 100 (when the solenoid is energized) of the hydraulic cylinder 72. Two 3000 PSI holding valves 82 are provided for each hydraulic cylinder 72, one for the rod side 98 and one for the bore side 100. The holding valves 82 are proportionally controlled by an electrical signal from the controller 80. Pressure sensors 102 are provided, both on the rod side 98 and on the bore side 100, to monitor pressure within the hydraulic cylinders 72 thereby ensuring a weather tight seal at all times.

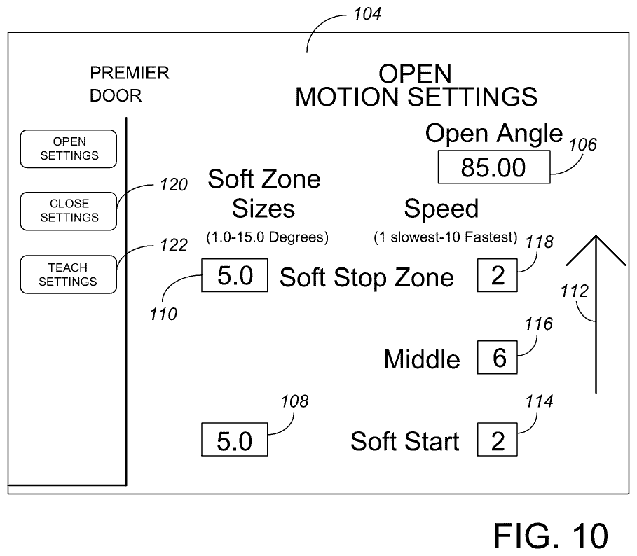

The system preferably includes a graphical user interface (GUI) 104 for programming settings into the controller 80, with one of its screens shown in FIG. 10. The GUI 104, preferably on a separate touchscreen installed as part of the door system 10 but alternatively provided on a computer (not shown) input via a wired connection (such as on a USB cable connection) or on a smartphone (not shown) input via a wireless connection (such as via Bluetooth), allows for input of variables, operation of the system and feedback regarding the system's status. Initial setup is performed by the installer and changes are allowed by the end user.

When the door panel 12 is first mounted, a “Motion Override” screen (not shown) in the GUI allows manual pressing of a button in the GUI to move the cylinders 72 either further open or further closed (provided no or few faults have been identified). During installation, the user should use the “Motion Override” screen by pressing and holding the Close button until the door panel 12 is firmly closed in the desired physical position. An initialization screen in the GUI is to “Teach Close Setpoint” when the door panel 12 is closed, to zero out the inclinometer reading and allow the closed rod pressure to be set, such as to any value within a preferred range of 500-2000 psi. The closed rod pressure will press the top corner 50 of the door panel 12 against the stationary front top header finishing plate 30, and will press the front side edge finishing plates 58 against the stationary support uprights 18. The Motion Override and Teach Close Setpoint GUI screens may also show readings for the current angle being sensed by the inclinometer 78, for rate of speed of the door panel 12 in degrees per second, and for rod pressure and bore pressure.

Once the Teach Close Setpoint has been completed, the Open Angle of the door panel 12 is selected via the GUI such as in the Open Motion Settings GUI screen 104 shown in FIG. 10. The Open Angle 106 is relative to zero (closed), and thus an angle of 90° is horizontal, i.e., theoretically parallel to the ground. In the example shown in FIG. 10, the user or installer has selected 85° for the fully opened position 106. During open operation the door 10 will stop when this angle is reached. Depending on speeds and Soft Zone Sizes (described below) it is possible for the door panel 12 to slightly pass the selected Open Angle 106 before coming to a complete stop.

The Open Motion Settings GUI screen 104 further allows “Soft Zones” to be set in degrees. Soft zones are angle ranges along the swing of the door panel 12 near the closed and open points in which settings can be manipulated to make the operation of the door panel 12 smoother. The soft zone sizes (angle ranges) are selectable via the GUI at a value between 1 and 15°. For instance, the example shown in FIG. 10 has a Soft Start zone 108 while the door panel 12 is starting to open within 0-5° of the closed position, and has a Soft Stop zone 110 while the door panel 12 is completing its opening motion from 80-85° from the closed position. Having larger values for Soft Zones 108, 110 will allow for smoother operation of the door and smaller values for Soft Zones 108,110 allow for faster operation. The top (soft stop) zone 108 and the bottom (soft start) zone 110 have independent sizes. The Middle zone for the door panel 12 is for the remaining portion of the swing of the door panel 12 that is outside the Soft Start and Soft Stop Zones, in the example of FIG. 10 during the opening motion from 5 to 80° from the closed position. An arrow graphic 112 on the screen indicates the order in which the zones and speed settings are processed.

Zone speeds 114, 116, 118 are values selected in GUI, used to operate the door panel 12 at desired speeds through each zone. Based on numbers entered via the GUI for the proportional driver minimum and maximum values, the system speeds are calculated across this spectrum and are simply represented as values of 1-10, 1 being the slowest and 10 the fastest.

A separate Close Motion Settings screen is available by clicking on a “Close Settings” button 120. The Close Motion Settings screen is identical to the Open Motion Settings screen of FIG. 10 but has a different title and has the arrow graphic pointing downward, allowing control of a set of variables with the same purposes as the Open Motion Settings. The Close Motion Settings are separate from the Open Motion Settings in part to allow greater control, but also because the closing of the door is different due to gravity.

The user can return to “Teach Settings” by clicking on button 122.

After these settings have been selected via the GUI, open operation is as follows:

1) Open motion is initiated by the user pressing an open button (not shown) when the auto mode of the powered garage door 10 is running.

2) Engage the hydraulic pumps 86 and open the appropriate proportional valve 82.

3) Accelerate flow to the cylinders 72 by incrementally increasing the proportional flow through the appropriate holder valve 82 until the door panel 12 reaches the selected speed of the zone in which motion was initiated.

4) If the next zone is reached and that zone's selected speed is greater than the current zone, accelerate to the new zone speed.

5) If the next zone is reached and that zone's selected speed is less that the current zone, decelerate to the new zone speed.

6) Once in the Open Top Soft Zone and the Open Angle is reached, turn pumps 86 off and cease operation.

Close operation is as follows:

1) Close motion is initiated by the user pressing a close button (not shown) when the auto mode of the powered garage door 10 is running.

2) Engage the hydraulic pump 86, switch the open/close solenoid valve 96 and open the appropriate proportional valve 82.

3) Accelerate flow to the cylinders 72 by incrementally increasing the proportional flow through the appropriate holder valve 82 until the door panel 12 reaches the selected speed of the zone in which motion was initiated.

4) If the next zone is reached and that zone's selected speed is greater than the current zone, accelerate to the new zone speed.

5) If the next zone is reached and that zone's selected speed is less that the current zone, decelerate to the new zone speed.

6) Once in the Close Bottom Soft Zone and an angle of zero is reached, deenergize the open/close valve 96, turn pumps 86 off and cease operation.

The merging of electronics and hydraulics together accomplish a reliable, efficient, smooth and completely “shock-free” door opening and closing for performance based hydraulic door operation, which is especially important for larger width openings. The control system has one touch soft start open and soft door closure, and has manual mode (press and hold) ability as well. The preferred electrical and hydraulic door performance features include:
Full range of door control in all aspects, via angle measurements preferably calculated by a single axis inclinometer 78;
Numerous speed options are preferably customer-selected via a graphical user interface (GUI) color touchscreen;
Full smooth ramping upon starting and stopping the door panel 12, provided by proportional valve controls in the hydraulic system. The smooth ramping system eliminates door slammage caused by insufficient prior art hydraulic systems with no control of door movement (the wider and taller the prior art door dimensions, the more common such deficiencies are. No control=door jarring+slammage). The smooth ramping system also eliminates building structure stress and strain from the door panel 12 itself, and eliminates chatter and loud noise associated with other doors; and
The GUI 104 preferably allows customization for door soft start open and soft start close “points”, so the speed profile for opening and closing the door panel 12 can be customized for the particular size and usage requirements of each individual door installation. All of integral components tied together (hydraulic, electrical, mechanical) are carefully selected or custom manufactured to create a high performance and over all durable package.

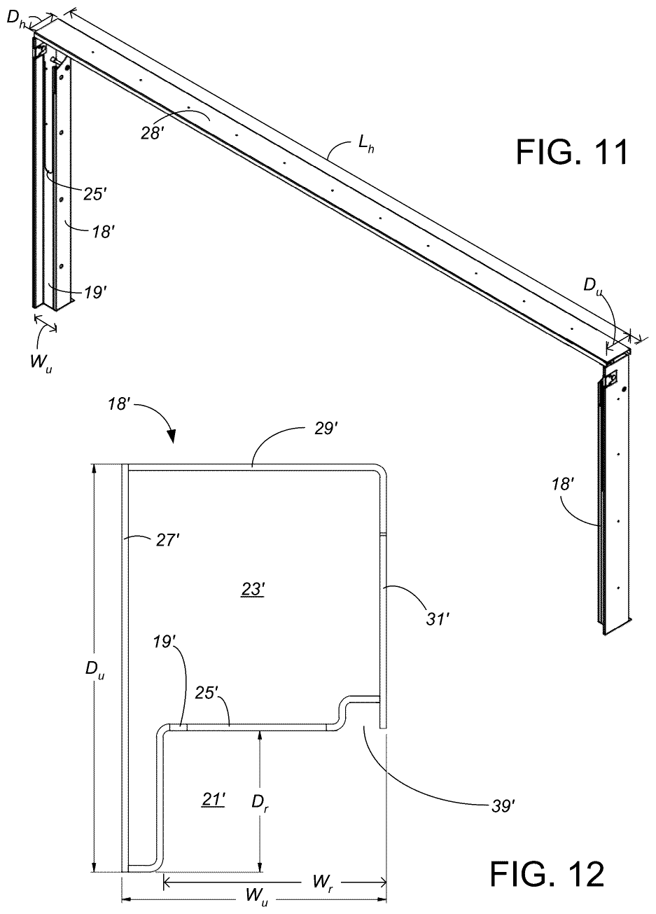

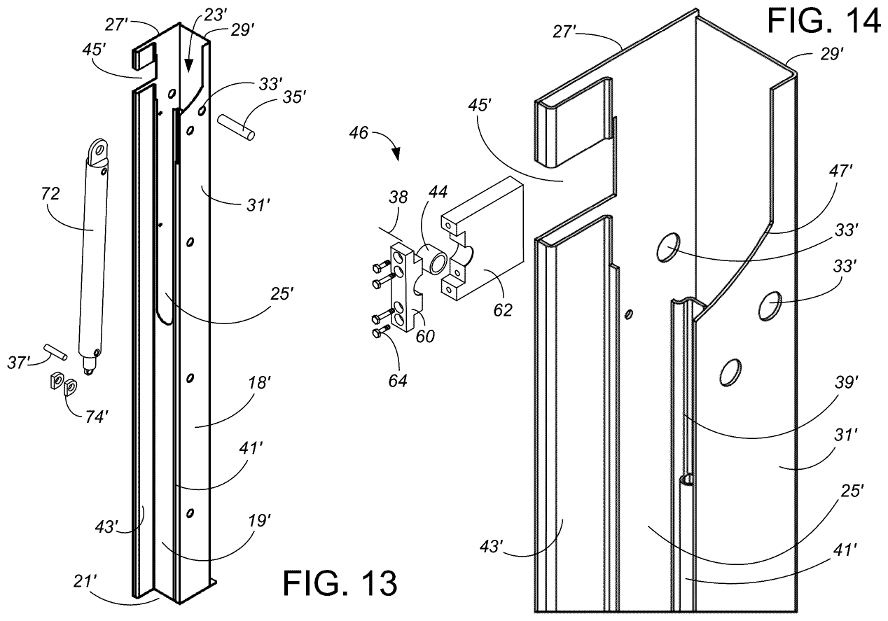

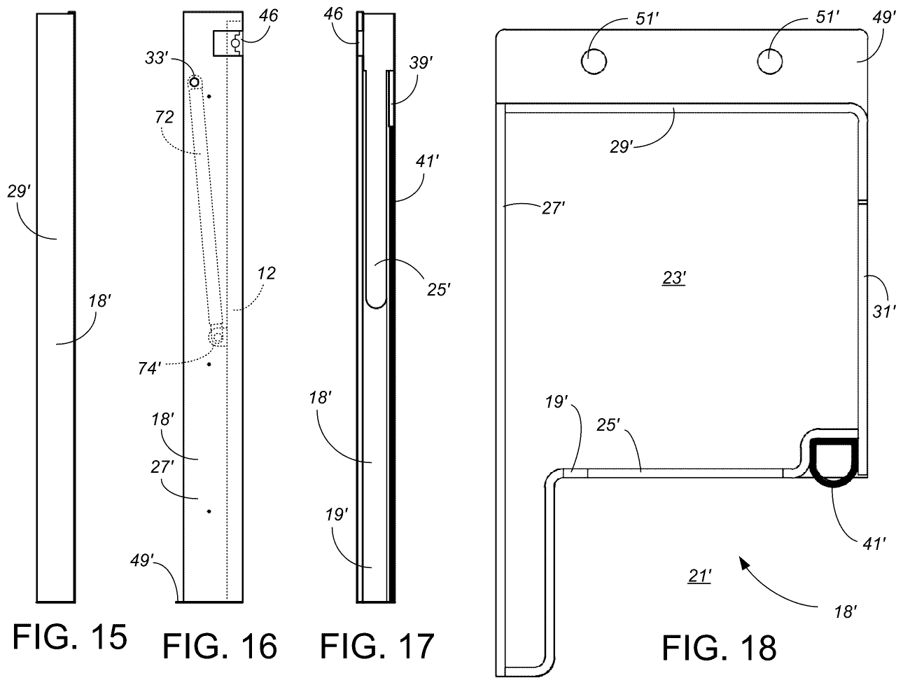

FIG. 11 shows the alternative set of uprights 18′ and header 28′ dimensioned for a differently sized door panel (not shown) but similarly constructed to the door panel 12 of FIG. 1. The right and left uprights 18′ have an upright height Hu which matches the height of the door panel 12 with a slight clearance such as being just over 112 inches (over 9 feet) tall in the depicted preferred embodiment with a clearance of about 2 inches or less over the closed door panel 12. Meanwhile the header 28′ has a header length Ln which is about four inches longer than the length of the door panel 12, such as having a header length Ln of over 286 inches in the depicted preferred embodiment for a door panel 12 of just over 282 inches (over 23 feet) wide. In contrast with the uprights 18 and header 28 of the first embodiment which were formed and shaped generally as desired in the construction of the rough opening for the garage door in the building, the alternative uprights 18′ and header 28′ are custom designed in shape and size to match the design objectives of the alternative garage door. In particular, the uprights 18′ are considerably deeper and wider than the standard construction uprights 18 depicted in FIG. 3-7 for the first embodiment, and provide not only structural strength but also house the respective hydraulic cylinder 72. The powered garage door of FIGS. 11-18 can accordingly be referred to as a “hidden cylinder” door. For instance, the preferred uprights 18′ have an upright depth Du of nearly 12 inches and an upright width Wu of over 7 inches. The header 28′ has a header depth Dh which generally matches the upright depth Du. In the preferred construction, the uprights 18′ and the header 28′ are all fabricated from steel as generally tubular members.

The front wall 19′ of each of the uprights 18′ defines a door recess 21′ exposed forwardly, and the rightmost and leftmost (i.e., outermost) studs 20 of the door panel 12 are received within these door recesses 21′ while the door panel 12 is in the vertical, closed position. For instance, the preferred embodiment has a recess depth Dr of about 4 inches and a recess width Wr of about 6 inches. The rear portion of each of the uprights 18′ defines a cylinder chamber 23′, which houses the entirely of the respective hydraulic cylinder 72 while the door panel 12 is in the closed position. A cylinder travel slot 25′ is defined on the front wall 19′ of each of the uprights 18′ between the cylinder chamber 23′ and the door recess 21′. Other than the cylinder travel slot 25′, each cylinder chamber 23′ is substantially enclosed by the outer wall 27′, the rear wall 29′ and the inner wall 31′ of the respective upright 18′. Accordingly, while the door panel 12 is closed, the hydraulic cylinders 72 are completely concealed from view by the uprights 18′ and the edges of the door panel 12.

The hydraulic cylinders 72 and the cylinder travel slots 25′ are positioned slightly wider on the door panel than where the attachment brackets 74 are shown in FIG. 1, such that the right and left attachment brackets 74′ can be generally aligned with or only slightly inside the outermost vertical studs 20. The outer wall 27′ and the inner wall 31′ on each upright 18′ include openings 33′ for an upper pivot pin 35′ for the respective hydraulic cylinder 72, while a lower pivot pin 37′ is used to pivotally attach the respective hydraulic cylinder 72 to the attachment brackets 74′ and therethrough to the door panel 12.

A forwardly facing seal pocket 39′ is defined on the front wall 19′ of each of the uprights 18′, extending vertically. The seal pockets 39′ are located toward the inside of the door panel 12 (i.e., away from the edge of the door panel 12) from the respective cylinder travel slot 25′, preferably adjacent the inner wall 31′ of the respective upright 18′. Each seal pocket 39′ is dimensioned to receive and support a seal 41′ shown in FIGS. 14, 17 and 18. The seals 41′ are formed of a soft, compressible material, preferably molded or extruded in a “D” shape out of an elastomer such as EDPM, vinyl, neoprene or rubber. The “D” shape, when uncompressed, extends beyond the metal face of the respective upright front wall 19′ defining the door recess 21′, but can be compressed rearwardly. The seals 41′ mate against the back surface of the door panel 12, and particularly against the back surfaces of the right and left outer vertical studs 20. To provide more space both for the attachment brackets 74′ and to mate against the seals 41′, as well as to provide additional strength, the outermost vertical studs 20 of the door panel 12 may be formed of 6×4 inch tubes rather than the 2×4 inch tubes depicted in FIG. 1. The seals 41′ not only help to prevent precipitation entry into the building while the door panel 12 is closed, but also to prevent airflow past the door panel 12 into or out of the building.

Each upright 18′ includes a forwardly extending portion 43′ which in part defines the door recess 21′ and is positioned wider than the edge of the door panel 12 (wider than the respective outermost vertical stud 20). A bushing assembly notch 45′ is located relatively high in this forwardly extending portion 43′, and the bushing assembly notch 45′ receives and supports the bushing assembly 46, with the bushing 44 defining the door pivot axis 38.

The inner wall 31′ of each of the uprights 18′ includes a cut-away section 47′. The cut-away sections 47′ allow the rearward and downward travel of the top edge 52 of the door panel 12 during opening of the door panel 12.

To improve the column strength of the upright 18′, the walls extend all the way downward to a bottom flange 49′ which can have bolt holes 51′ allowing it to be bolted to the floor (not shown) of the building (such as into concrete anchors, not shown). That is, the inner wall 31′ does not include a cut-away for the foot plate 22. Instead, the footplate 22 shown in FIG. 1 is modified by removing the portion of the foot plate 22 which might otherwise contact the inner wall 31′ or the front wall 19′ in the closed position, i.e. the ends of the footplate 22 are shaped to fit within the door recess 21′.

Although the present invention has been described with reference to preferred embodiments, workers skilled in the art will recognize that changes may be made in form and detail without departing from the spirit and scope of the invention. In particular, the dimensions given are examples which work for a particular situation, and workers skilled in the art will be able to adjust dimensions appropriately for the size and strength requirements of a particular installation.

What is claimed is:

1. A powered garage door for use in a building having a door opening defined underneath a header between two uprights, the two uprights including a left upright and a right upright when viewed from outside the building, the header and the two uprights each having a rear face, the powered garage door comprising:
a door panel having a top edge, the top edge, when the door panel is in a closed position wherein the door panel extends generally in alignment with the two uprights, extending underneath and abutting a bottom side of the header with a vertical clearance, the door panel having left and right side edges when viewed from outside the building, the left side edge, when the door panel is in the closed position, abutting the left upright, the right side edge, when the door panel is in the closed position, abutting the right upright, the door panel having a bottom edge which, in the closed position, extends between the two uprights;
left and right pivot connectors attached to the door panel to pivotally connect the door panel to the two uprights for pivoting about a fixed pivot axis extending from the left side edge to the right side edge, such that when the door panel moves from the closed position to an opened position the top edge moves rearwardly into the building while the bottom edge moves forwardly away from the building, the fixed pivot axis being forward of the rear faces of the two uprights and forward of the rear face of the header;
at least one linear actuator positioned behind the door panel so as to be protected from precipitation by the building when the door panel is in the closed position, the at least one linear actuator being attached to the door panel at an attachment bracket, the attachment bracket, when the door panel is in a closed position, being lower than the fixed pivot axis, the linear actuator being controllable to extend from a shortened position to a lengthened position or to retract from the lengthened position to the shortened position; and
a front top header finishing plate, fixed so as to extend downwardly from the header across the vertical clearance and in front of and beneath the top edge when the door panel is in the closed position, such that the front top header finishing plate resists precipitation entry between the header and the top edge of the door panel when the door panel is in the closed position.

2. The powered garage door of claim 1, further comprising:
left and right front side edge finishing plates, the left front side edge finishing plate fixed to the left side edge of the door panel and extending outwardly/leftwardly therefrom, such that, when the door panel is in a closed position, the left front side edge finishing plate abuts a front face of the left upright and resists precipitation entry between the left upright and the left side edge of the door panel, the right front side edge finishing plate fixed to the right side edge of the door panel and extending outwardly/rightwardly therefrom, such that, when the door panel is in a closed position, the right front side edge finishing plate abuts a front face of the right upright and resists precipitation entry between the right upright and the right side edge of the door panel.

3. The powered garage door of claim 2, further comprising:
two front side upright finishing plates, each fixed so as to extend downwardly from an end of the front top header finishing plate, the two front side upright finishing plates being in plane with the front top header finishing plate with the door panel in both the closed position and the opened position, the two front side upright finishing plates being in plane and in line with the two front side edge finishing plates when the door panel is in the closed position.

4. The powered garage door of claim 1,
wherein the door panel comprises:
a frame skeleton having a hollow tubular crossbar running between the side edges; and
sheet material secured to the frame skeleton;
and wherein the pivot connectors comprise:
a pivot arm received partially within the hollow tubular crossbar; and
a cylindrical door pivot integrally formed with the pivot arm, extending horizontally about the fixed pivot axis outside the hollow tubular crossbar.

5. The powered garage door of claim 1, wherein a top of the at least one linear actuator while the door panel is in the closed position is lower than the fixed pivot axis.

6. The powered garage door of claim 5, wherein the linear actuator is disposed within a chamber within one of the uprights while the door panel is in the closed position.

7. The powered garage door of claim 1, wherein the door panel comprises:
a skeleton frame structure with a plurality of studs which extend vertically when the door panel is in the closed position, the plurality of studs generally establishing the thickness of the door panel when viewed from a side; and
a sheet of material covering a front side of the plurality of studs, the sheet being continuous and generally flat on the entirety of the skeleton frame structure;
wherein the fixed pivot axis is closer to the sheet of material than the thickness of the door panel.

8. The powered garage door of claim 1, further comprising:
an inclinometer sensor secured to the door panel to provide an inclinometer signal indicating inclination angle of the door panel, and
an electronic controller receiving the inclinometer signal and controlling the linear actuator to extend or retract based on the inclinometer signal.

9. The powered garage door of claim 8, wherein a rate of extension or retraction of the linear actuator is controlled by the electronic controller based on the inclinometer signal.

10. The powered garage door of claim 9, further comprising a user interface, the user interface allowing a user to select one or more change angles at which the electronic controller changes the rate of extension or retraction of the linear actuator based on the inclinometer signal.

11. The powered garage door of claim 10, wherein the user interface allows the user to select at least one of the change angles used for opening of the door panel changing the rate of extension of the linear actuator to have a different value than any of the change angles used for closing of the door panel changing the rate of retraction of the linear actuator.

12. The powered garage door of claim 10, wherein the user interface allows the user to select different speeds for extension or retraction of the linear actuator at different ranges of values of the inclination angle.

13. A building with a powered garage door, comprising:
a door opening defined underneath a header between two uprights, the two uprights including a left upright and a right upright when viewed from outside the building, the two uprights each defining an interior chamber;
the powered garage door comprising:
a door panel having a top edge, the top edge, when the door panel is in a closed position wherein the door panel extends generally in alignment with the two uprights, extending underneath and abutting a bottom side of the header with a clearance, the door panel having left and right side edges when viewed from outside the building, the left side edge, when the door panel is in the closed position, abutting the left upright, the right side edge, when the door panel is in the closed position, abutting the right upright, the door panel having a bottom edge which, in the closed position, extends between the two uprights;
left and right pivot connectors attached to the door panel to pivotally connect the door panel to the two uprights for pivoting about a fixed pivot axis extending from the left side edge to the right side edge, such that when the door panel moves from the closed position to an opened position the top edge moves rearwardly into the building while the bottom edge moves forwardly away from the building;
left and right linear actuators, the left linear actuator being pivotally attached to the left upright within its interior chamber at a position higher than the fixed pivot axis and being pivotally attached to the door panel at a position lower than the fixed pivot axis when the door panel is in a closed position such that, when the door panel is in a closed position, the left linear actuator is within the interior chamber of the left upright, the right linear actuator being pivotally attached to the right upright within its interior chamber at a position higher than the fixed pivot axis and being pivotally attached to the door panel at a position lower than the fixed pivot axis when the door panel is in a closed position such that, when the door panel is in a closed position, the right linear actuator is within the interior chamber of the right upright, each of the left and right linear actuators being controllable to extend from a shortened position to a lengthened position for opening of the door panel or to retract from the lengthened position to the shortened position for closing of the door panel.

14. The building with a powered garage door of claim 13, wherein the left upright and the door panel substantially hide the left linear actuator from view while the door panel is in the closed position, and wherein the right upright and the door panel substantially hide the right linear actuator from view while the door panel is in the closed position.

15. The building with a powered garage door of claim 13, wherein the left upright comprises a front wall defining a cylinder travel slot through which the left linear actuator moves during opening and closing of the door panel, and wherein the right upright comprises a front wall defining a cylinder travel slot through which the right linear actuator moves during opening and closing of the door panel.

16. The building with a powered garage door of claim 13, wherein the left upright comprises an inner wall having a cut-away section, and wherein the right upright comprises an inner wall having a cut-away section, the cut-away sections of the left and right uprights allowing rearward and downward travel of the top edge of the door panel during opening of the door panel.

17. The building with a powered garage door of claim 13, further comprising left and right compressible seals each extending vertically and compressing against a rear face of the door panel when the door panel is in a closed position, the left compressible seal contacting the door panel at a location which is further from the left edge of the door panel than where the left linear actuator is pivotally attached to the door panel, the right compressible seal contacting the door panel at a location which is further from the right edge of the door panel than where the right linear actuator is pivotally attached to the door panel.

18. A building with a powered garage door, comprising:
a door opening defined underneath a header between two uprights, the two uprights including a left upright and a right upright when viewed from outside the building;
the powered garage door comprising:
a door panel having a top edge, the top edge, when the door panel is in a closed position wherein the door panel extends generally in alignment with the two uprights, extending underneath and abutting a bottom side of the header with a clearance, the door panel having left and right side edges when viewed from outside the building, the left side edge, when the door panel is in the closed position, abutting the left upright, the right side edge, when the door panel is in the closed position, abutting the right upright, the door panel having a bottom edge which, in the closed position, extends between the two uprights;
left and right pivot connectors attached to the door panel to pivotally connect the door panel to the two uprights for pivoting about a fixed pivot axis extending from the left side edge to the right side edge, such that when the door panel moves from the closed position to an opened position the top edge moves rearwardly into the building while the bottom edge moves forwardly away from the building;
left and right linear actuators, the left linear actuator having a first end pivotally supported at a position higher than the fixed pivot axis and having a second end pivotally attached to the door panel at a position lower than the fixed pivot axis when the door panel is in a closed position, the right linear actuator having a first end pivotally supported at a position higher than the fixed pivot axis and having a second end pivotally attached to the door panel at a position lower than the fixed pivot axis when the door panel is in a closed position, each of the left and right linear actuators being controllable to extend from a shortened position to a lengthened position for opening of the door panel or to retract from the lengthened position to the shortened position for closing of the door panel; and
left and right compressible seals each extending vertically and compressing against a rear face of the door panel when the door panel is in a closed position, the left compressible seal contacting the door panel at a location which is further from the left edge of the door panel than where the left linear actuator is pivotally attached to the door panel, the right compressible seal contacting the door panel at a location which is further from the right edge of the door panel than where the right linear actuator is pivotally attached to the door panel.

19. The building with a powered garage door of claim 18, wherein the left upright comprises a seal pocket for receiving the left compressible seal, and wherein the right upright comprises a seal pocket for receiving the right compressible seal.

20. The building with a powered garage door of claim 18, wherein the door panel comprises a skeleton frame structure with a left outermost stud and a right outermost stud, wherein the left compressible seal compresses against a rear face of the left outermost stud, and wherein the right compressible seal compresses against a rear face of the right outermost stud.
